(19) United States
(12) Patent Application Publication
(10) Pub. No.: US 2021/0357545 A1
(43) Pub. Date: Nov. 18, 2021

(54) WORK INSTRUCTION SYSTEM AND METHOD

(71) Applicant: Hitachi, Ltd., Tokyo (JP)

(72) Inventors: Yoshio SUGAWARA, Tokyo (JP); Tomoyuki YAMAGATA, Tokyo (JP); Masahiro MURAKAMI, Tokyo (JP); Takayuki TAKEZAWA, Tokyo (JP); Ikuo KOIBUCHI, Tokyo (JP); Yoshio YAMAMURA, Tokyo (JP)

(21) Appl. No.: 17/285,119

(22) PCT Filed: Dec. 13, 2019
(86) PCT No.: PCT/JP2019/049035

§ 371 Date: Apr. 14, 2021

(30) Foreign Application Priority Data
Mar. 11, 2019 (JP) 2019-044183

(51) Int. Cl. G06F 30/17; G05B 19/4099; G06F 30/12

(52) U.S. Cl. CPC G06F 30/17; G06F 2113/16; G06F 30/12; G05B 19/4099

(57) ABSTRACT

The work instruction system includes: a computer configured to generate a work instruction screen; and a display device connected to the computer and configured to display the work instruction screen. The work instruction screen includes a first display region in which a three-dimensional model used for describing an assembly work of an object is displayed based on three-dimensional design data, a second display region 320 in which at least a part of attribute information of the three-dimensional design data is displayed, and a third display region in which when predetermined component information registered in advance is included in the attribute information, related information associated with the predetermined component information is displayed. In the first display region, when the object is a wiring line, the three-dimensional model is displayed for allowing a first predetermined operation.

### TECHNICAL FIELD

The present invention relates to a work instruction system and a work instruction method.

### BACKGROUND ART

Various factories for control panels, office equipment, automobiles, aircraft, industrial machinery, construction machinery, and the like produce products by production methods such as a line method, a cell method, and a dynamic cell method. One product is produced through a plurality of work processes such as preparation of components and materials, sheet metal, coating, assembly of main components, assembly of main components to the main body, and inspection.

An assembly work system that instructs workers on assembly work is placed at the production site (PTL 1 and 2). Such an assembly work system presents the components to be assembled, the assembly method, and the jig used for assembly to the worker.

### CITATION LIST

### Patent Literature

PTL 1: JP 2001-242928 A

PTL 2: JP 2012-118690 A

### SUMMARY OF INVENTION

### Technical Problem

PTL 1 merely displays an image showing a component assembly scene, and a sentence related to a work procedure on a data display unit (PTL 1, paragraph 0022). PTL 2 displays the model of the component, the order of incorporation, the jig number used for incorporation, and the precautions for incorporation as text, and does not display an image.

As described above, in the conventional techniques, since the three-dimensional model based on the three-dimensional design data on the object is not presented to the worker, it may take time for the worker to three-dimensionally understand the outer shape, the mounting position, the size, and the like of the object.

Of the objects for assembling work, the wiring line such as an electric cable, a harness, or a lead wire has an elongated soft structure, and is used to connect distant portions, such as between the front and back sides of the housing or between the top and bottom of the housing.

Furthermore, since part of the wiring line passes through the back side of another component, the wiring line is mounted along a complicated path as compared with another box-shaped or plate-shaped component. As described above, it is difficult and time-consuming to explain to the worker the assembling method of the wiring line that connects the distant portions in a complicated path.

The present invention has been made in view of the above problems, and has an object to provide a work instruction system and a work instruction method capable of improving usability.

### Solution to Problem

In order to solve the above problems, the work instruction system according to the present invention is a work instruction system configured to display a work instruction on assembly work, the work instruction system including: a computer configured to generate a work instruction screen; and a display device connected to the computer and configured to display the work instruction screen. The work instruction screen includes: a first display region in which a three-dimensional model used for describing an assembly work of an object is displayed based on three-dimensional design data, a second display region in which at least a part of attribute information of the three-dimensional design data is displayed, and a third display region in which when predetermined component information registered in advance is included in the attribute information, related information associated with the predetermined component information is displayed. In the first display region, when the object is a wiring line, the three-dimensional model is displayed for allowing a first predetermined operation.

### Advantageous Effects of Invention

According to the present invention, the worker can grasp the work contents three-dimensionally through the work instruction screen. Furthermore, when the object is a wiring line, the three-dimensional model can be displayed for allowing a first predetermined operation, the wiring assembly work can be easily checked, and the usability is improved.

### BRIEF DESCRIPTION OF DRAWINGS

FIG. 1 is an explanatory diagram showing an overall outline of a work improvement support system including a work instruction system according to the present embodiment.

FIG. 2 is an example of a computer system that achieves a work improvement support system.

FIG. 3 is an example of a table that manages work instructions.

FIG. 4 is a flowchart showing processing of generating a work instruction.

FIG. 5 is a flowchart showing processing of checking wiring assembly work at a work site.

FIG. 6 is a flowchart showing processing of checking assembly work of a component other than a wiring line at a work site.

FIG. 7 is an example of a screen for instructing wiring assembly work.

FIG. 8 is an example of a screen for instructing assembly work of a component other than a wiring line.

FIG. 9 is a perspective view schematically showing an example of a portion of a connection destination of the wiring line, a portion where the wiring line goes through another component, and a portion where the wiring line is hidden.

FIG. 10 is a flowchart showing processing of checking wiring assembly work at a work site, according to a second embodiment.

FIG. 11 is a flowchart showing processing of determining the end of wiring assembly work from the operating situation of a tool, according to a third embodiment.

FIG. 12 is a flowchart showing processing of controlling a screen for instructing a work site depending on a tool type and a set value according to a fourth embodiment.

FIG. 13 is an explanatory diagram showing a state in which an e-mail is transmitted from a work instruction screen according to a fifth embodiment.

FIG. 14 is a flowchart showing processing of notifying matters noticed during work.

FIG. 15 is a flowchart showing processing of correcting a work instruction screen based on a work analysis result and/or a communication from a site.

### DESCRIPTION OF EMBODIMENTS

Hereinafter, embodiments of the present invention will be described with reference to the drawings. A work instruction system 11 according to the present embodiment provides a three-dimensional model based on the three-dimensional design data of the component being the object of the assembly work, at least a part of the attribute information about the three-dimensional design data, and the related information associated with the predetermined component information included in the attribute information to workers as a work instruction screen. Furthermore, when the component of the object is a wiring line, the work instruction system 11 displays a three-dimensional model used for explaining the wiring assembly work so that the first predetermined operation can be performed, thereby informing the worker of the assembly work method of the wiring difficult to understand at a glance.

### First Embodiment

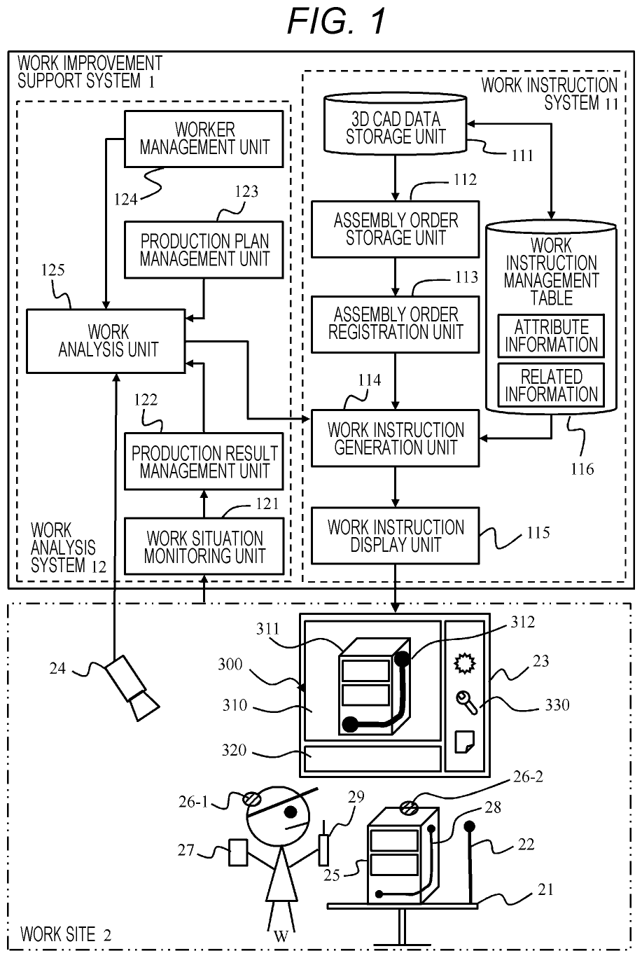

The first embodiment will be described with reference to FIGS. 1 to 9. FIG. 1 is an explanatory diagram showing an overall outline of a work improvement support system 1. The work improvement support system 1 includes a work instruction system 11 and a work analysis system 12. Instead of this, the work improvement support system 1 can also be referred to as an information processing system including the work instruction system 11.

The work improvement support system 1 provides a work instruction screen 300 to the worker who performs assembly work at a work site 2, and collects and analyzes the work result of the worker. In another embodiment described below, the work improvement support system 1 can also correct the work instruction screen based on the work analysis result and/or the communication from the worker.

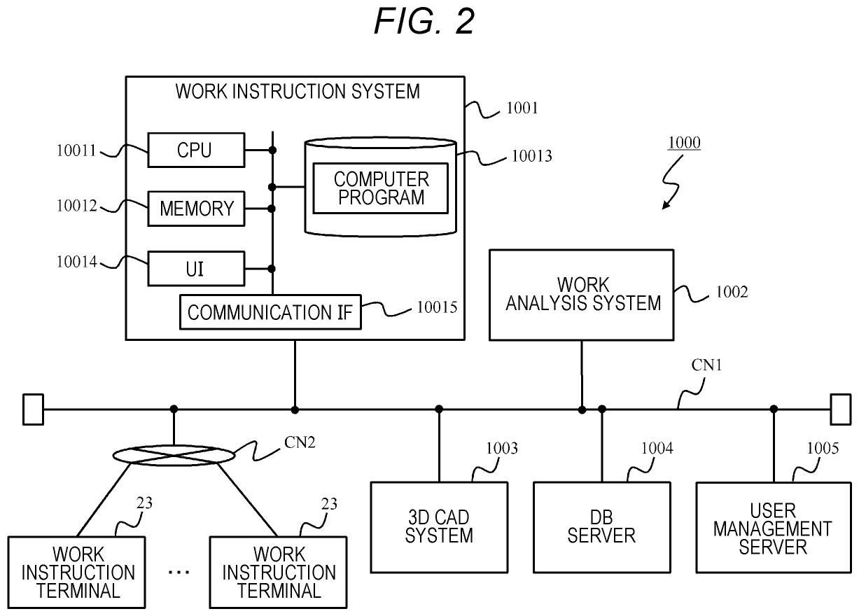

The work improvement support system 1 can be configured using, for example, at least one computer. An example of a computer system that achieves the work improvement support system 1 will be described below in FIG. 2.

First, the work site 2 will be described. The work site 2 includes at least one cell 21. In the cell 21, the worker W produces a product 25 according to the work procedure displayed on a work instruction terminal 23.

Here, the cell production method will be described as an example, but the present invention is not limited to this, and may be applied to the line method and the dynamic cell method. In addition, the work site 2 of the present embodiment is suitable for what is called high-mix low-volume production, but can also be applied to low-mix high-volume production and low-mix low-volume production.

At least one camera 24 for monitoring the work situation of the worker W is installed in the cell 21. The camera 24 may monitor not only the work situation but also the situation around the cell 21.

A radio frequency identifier (RFID) reader 22 that reads information from an RFID tag 26 is provided in the cell 21 or near the cell 21. Here, the RFID tag 26 can be divided into, for example, a work tag 26-1 held by the worker W and a product tag 26-2 provided on the product 25.

The work tag 26-1 can be further divided into a worker tag that stores the identification information about the worker W and a work instruction card tag that indicates the cell at the placement destination of the worker (placement destination process) (both not shown). The RFID reader 22 reads the identification information that identifies the worker and the identification information that identifies the cell (process) from the work tag 26-1. The work improvement support system 1 can grasp which worker is assigned to which cell 21 based on the information read by the RFID reader 22. In addition, acquiring the information about the product 25 from the product tag 26-2 makes it possible to grasp the current position and the manufacturing history of the product 25.

The work instruction terminal 23 as an example of the “display device” displays a work instruction screen 300 that teaches the worker the work procedure in the cell 21. The work instruction screen 300 includes a first pane 310 being an example of the “first display region”, a second pane 320 being an example of the “second display region”, and a third pane 330 being an example of the “third display region”.

In the first pane 310, a three-dimensional model 311 of an assembly target product 25 and a three-dimensional model 312 of an assembly target component 28 are displayed. Here, the component includes a wiring line 28 such as a cable, a lead wire, or a harness. The three-dimensional model 312 of the component 28 to be the object of the work procedure can be highlighted so as to be distinguished from that of another component. For highlighting, for example, methods such as changing the color of a component to a color different from that of another component, thickening a line, and blinking can be adopted.

The worker can perform a predetermined operation (first predetermined operation) on the three-dimensional models 311 and 312 in order to check the connection position, mounting position, passing position, and the like of the wiring line 312 displayed in the first pane 310.

The predetermined operation includes operations of, for example, rotating the three-dimensional model 311 of the product, making a part of the three-dimensional model 311 of the product transparent, erasing other components included in the three-dimensional model 311 of the product, and enlarged-displaying or reduced-displaying the portion where the three-dimensional model 312 of the wiring line is connected or passes through in the three-dimensional model 311 of the product.

In the case of components other than wiring lines, for example, three-dimensional models of a liquid crystal display, a sequencer, a relay, a switch, a power supply, and the like are not complicated in assembly work as compared with those of wiring lines, and can be understood at a glance, so that the predetermined operation (second predetermined operation) is limited. Only limited operations such as rotation operations can be permitted for three-dimensional models of non-wiring components.

In the second pane 320, at least a part of the attribute information included in the three-dimensional design data of the product 25 (for example, part of the attribute information about the components to be assembled to the product 25) is displayed.

In the third pane 330, when a predetermined component code is included in the attribute information, related information associated with the component code is displayed. The predetermined component code is an example of “predetermined component information”. The related information can include any one of work precautions, information on a predetermined tool required when a target component is assembled into a target product, and information on the target product or other components related to the target product, for example. As will be clarified in the embodiment described below, it is also conceivable that the related information does not exist, in which case the third pane 330 is not provided on the work instruction screen 300.

When one work procedure is completed, the worker operates a completion button indicating the completion of the work procedure or a next button (both not shown) requesting the display of the next work procedure on the work instruction screen 300. The work improvement support system 1 can grasp the progress of the work procedure in each cell 21 in real time by monitoring the operation on the work instruction terminal 23 (work instruction screen 300). It should be noted that in another embodiment described below, the completion of the wiring assembly work is automatically detected by monitoring the operating situation of the tool (for example, an automatic driver) used for the wiring assembly work.

The worker W can also have a worker terminal 27. The worker terminal 27 is, for example, a mobile phone (including what is called a smartphone) or a mobile information terminal, provided by the company. The worker terminal 27 may be configured as what is called a wearable terminal such as a glasses type or a watch type, for example. At least any one of the worker terminal 27 and the work instruction terminal 23 may be configured as an augmented reality (AR) terminal.

The configuration of the work improvement support system 1 will be described. As described above, the work improvement support system 1 includes the work instruction system 11 and the work analysis system 12. First, the work instruction system 11 will be described.

The work instruction system 11 generates a work instruction screen 300 to be provided to the worker W in each cell 21. The work instruction system 11 includes, for example, a 3D CAD data storage unit 111, an assembly order storage unit 112, an assembly order registration unit 113, a work instruction generation unit 114, a work instruction display unit 115, and a work instruction management table 116.

The 3D CAD data storage unit 111 stores the three-dimensional design data (3D CAD data) output by the three-dimensional CAD system (not shown).

The assembly order storage unit 112 stores information about the assembly order automatically or manually generated from the 3D CAD data. The assembly order information is information indicating which components are to be mounted in which order and where, when the product 25 is manufactured.

The assembly order registration unit 113 registers the assembly order information used for the work instruction regarding the assembly of the product 25 being the object, among pieces of the assembly order information stored in the assembly order storage unit 112.

The work instruction generation unit 114 generates the work instruction contents to be displayed on the work instruction screen 300 from the assembly order information registered in the assembly order registration unit 113, the attribute information and related information stored in the work instruction management table 116.

In the present embodiment, as described above, among the work instruction contents, the contents related to the wiring assembly work differs from the contents related to the assembly work of components other than the wiring lines in the types of operations (rotation, enlargement, reduction, transparency, and the like) that the worker can perform. In view of the technical peculiarities of wiring that connects remote portions of product 25 via complicated routes, a wide variety of operations are available for the three-dimensional models 311 and 312 so that the worker can easily and sufficiently check the necessary information about the wiring assembly work.

The work instruction display unit 115 causes the work instruction terminal 23 to display the work instruction screen 300 by generating data on the work instruction contents generated by the work instruction generation unit 114 and transmitting the data to the work instruction terminal 23.

It should be noted that not all of the above-described functions 111 to 116 are needed to be provided in the work improvement support system 1. For example, the 3D CAD data storage unit 111 and the assembly order storage unit 112 may be provided outside the system 1.

The work analysis system 12 will be described. The work analysis system 12 monitors and analyzes the work results of each worker W in each cell 21. The work analysis system 12 includes, for example, a work situation monitoring unit 121, a production result management unit 122, a production plan management unit 123, a worker management unit 124, and a work analysis unit 125. Furthermore, the work analysis system 12 includes a user interface device (not shown) for a user such as a work analyst to exchange information with the work analysis system 12.

It should be noted that not all the entities of these functions 121 to 125 are needed to be provided in the work improvement support system 1. For example, the work situation monitoring unit 121, the production result management unit 122, the production plan management unit 123, and the worker management unit 124 may be provided outside the work improvement support system 1, and only necessary information may be transmitted from these external functions 121 to 124 to the work analysis unit 125.

The work situation monitoring unit 121 monitors the progress of work in each cell 21 based on the identification information read from the RFID tag 26 by the RFID reader 22 in each process and the operation of the work instruction terminal 23 by the worker, and sends the progress to the production result management unit 122.

The production result management unit 122 manages the production results for each cell (process) based on the data from the work situation monitoring unit 121.

The production plan management unit 123 manages the production plan of the work site 2. The production plan management unit 123 manages the production plan for the entire production site and the production plan by cell.

The worker management unit 124 manages, for example, the worker number, name, working style, working hours, history of the process in charge, the presence/absence of skills required in each cell, and the like, of each worker. Information managed by the worker management unit 124 is written in the work tag 26-1.

The work analysis unit 125 analyzes the work situation in each cell based on the production result data on each cell managed by the production result management unit 122 and the production plan by each cell managed by the production plan management unit 123. For example, the work analysis unit 125 can analyze whether or not a bottleneck work has occurred from the actual value (working hours) and the target value (target working hours) of each work.

A user such as a production control manager in charge of improving a working process can devise a measure for improving working efficiency based on the analysis result of the work analysis unit 125. After verification, the devised measures are adopted as work procedure instruction information and reflected in the work instruction screen 300.

FIG. 2 is an example of a computer system that achieves the work improvement support system 1. A computer system 1000 is configured by connecting, via a communication network CN1, a work instruction system server 1001, a work analysis system server 1002, a 3D CAD system 1003, a database server 1004, and a user management server 1005, for example. Furthermore, the work instruction system server 1001 and the work analysis system server 1002 are also connected to the work instruction terminal 23 of each cell 21 via the communication network CN2.

The work instruction system server 1001 is a server that achieves the work instruction system 11. The work instruction system server 1001 includes computer resources such as a microprocessor (abbreviated as CPU) 10011, a memory 10012, a storage device 10013, a user interface device 10014, and a communication unit 10015. The microprocessor 10011 reads the computer program stored in the storage device 10013 into the memory 10012 and executes the computer program, thereby achieving the function as the work instruction system 11.

The work analysis system server 1002 is a server that achieves the work analysis system 12. The work analysis system server 1002 also includes computer resources such as a microprocessor and memory (both not shown). The microprocessor (not shown) executes the computer program (not shown), thereby achieving the function as the work analysis system 12. In FIG. 2, the work instruction system server 1001 and the work analysis system server 1002 are shown as if they are configured as separate physical computers. Instead, the servers 1001 and 1002 may be configured as virtual computers, and may be provided on one physical computer.

The 3D CAD system 1003 is a computer that generates and outputs three-dimensional design data on the product 25 and each component constituting the product 25. The database server 1004 stores data and the like from the work site 2. The user management server 1005 manages users (for example, system administrator, analyst, work instruction creator, designer, and the like) who use the work improvement support system 1.

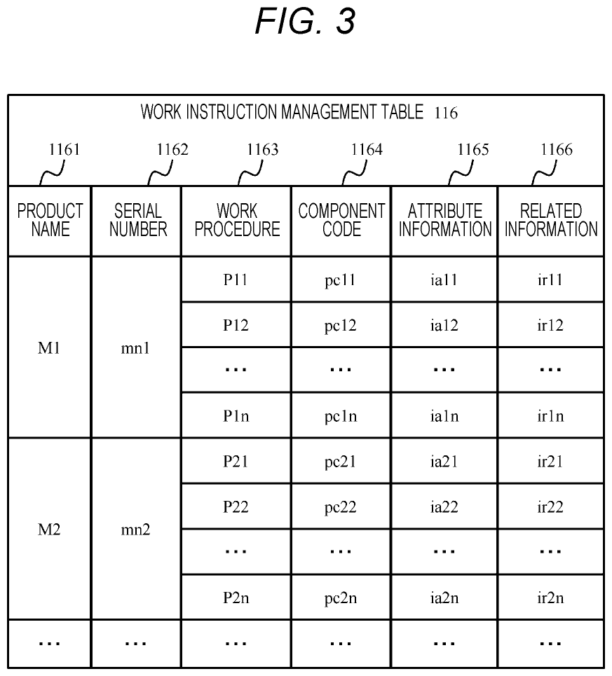

FIG. 3 shows an example of the work instruction management table 116. The work instruction management table 116 manages the contents of work instructions. The work instruction management table 116 is prepared for each product, for example.

The work instruction management table 116 includes, for example, product names 1161, serial numbers 1162, work procedure numbers 1163, component codes 1164, attribute information 1165, and related information 1166. The work instruction management table 116 may include items other than the items shown in FIG. 3, or does not have to include some of the items shown in FIG. 3. The work instruction management table 116 does not have to be configured with one table, and may include a plurality of tables.

The product name 1161 is a name or model number of the product. The serial number 1162 is information for identifying the product. The work procedure number 1163 is information for identifying the work procedure, such as a work name. The component code 1164 is information for identifying a component for the assembly work target.

The attribute information 1165 is attribute information about 3D CAD data. The attribute information includes, for example, the name of the component specified by the component code, the information for identifying the department that manufactured the component, the quantity of the component used for the assembly work, the information for specifying the CAD data of the component, and the like. The component code is also one of the attribute information, but in FIG. 3, the component code and the attribute information are displayed separately for convenience.

When the attribute information includes information (component code) for specifying a predetermined component, the related information 1166 is predetermined information associated with the predetermined component information in advance. The related information includes, for example, as described below in FIG. 7, work precautions 331, information 332 about other components related to the component to be worked on, information 333 about the tools used for the assembly work of the component to be worked on, and other information 334. The other information 334 can include, for example, general precautions about the product 25 and general information applied to a plurality of components that constitute the product 25. The information 333 about tools includes information for specifying a tool used for the assembly work and a set value of the tool (such as tightening torque).

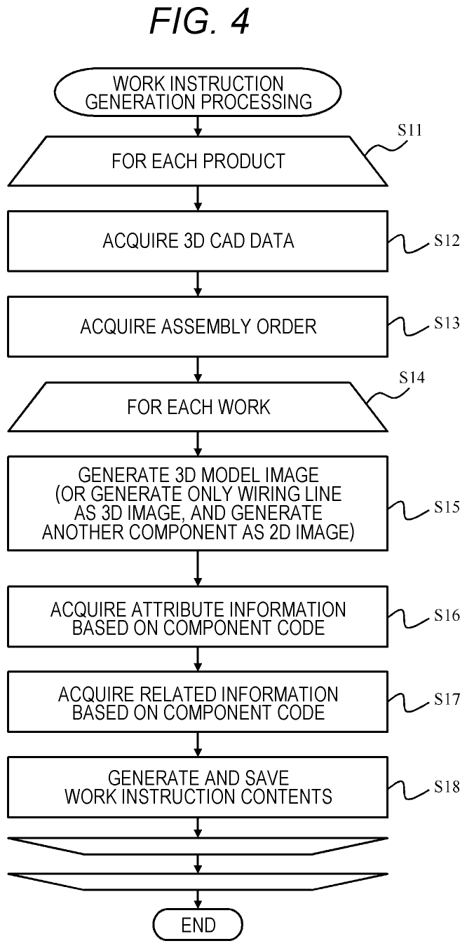

FIG. 4 is a flowchart of the work instruction generation processing. The work instruction system 11 executes each of the following steps S12 to S18 for each product (S11).

The work instruction system 11 acquires the 3D CAD data on the target product 25 from the 3D CAD data storage unit 111 (S12). Furthermore, the work instruction system 11 acquires the assembly order information registered in the assembly order registration unit 113 among pieces of the assembly order information obtained by analyzing the 3D CAD data or the like (S13).

The work instruction system 11 executes steps S15 to S18 for each work procedure (S14). That is, the work instruction system 11 generates image data in which a three-dimensional model of the component to be worked on is drawn based on the 3D CAD data acquired in step S12 (S15).

Of the components included in the product 25, it is also possible to generate only the wiring line as 3D model image data and to generate the components other than the wiring line as two-dimensional image data. In the case of a wiring line, for example, it is preferable that the wiring line is drawn as a 3D model so that the worker can easily check the position of the connection destination and the route in which the wiring line is routed, and it is preferable that operations such as rotation and enlargement/reduction are possible.

On the other hand, in the case of components other than the wiring line, such as switches, buttons, controllers, relays, display panels, and power supply devices, the mounting position is normally limited to a specific position of the product 25 and can be visually recognized at a glance. Therefore, in the case of non-wiring components, it is also considered that a two-dimensional image is sufficient for illustration and a 3D model is not required. Thus, for example, in the case of a skilled worker who has a predetermined experience, the assembly work method can be illustrated using a 3D model only for wiring lines, and in the case of an unskilled worker, the assembly work method can also be illustrated using a 3D model for all components. In the following, an example of generating 3D model image data for all components will be described, but as described above, 2D model image data (two-dimensional image data) may be generated in the case of non-wiring components.

The work instruction system 11 acquires attribute information such as a component name, a required quantity, and a manufacturing department from the work instruction management table 116 based on the component code included in the 3D CAD data acquired in step S12 (S16).

The work instruction system 11 acquires related information from the work instruction management table 116 based on the component code included in the 3D CAD data (S17).

The work instruction system 11 generates and saves the work instruction contents for being displayed on the work instruction screen 300 based on the 3D image data generated in step S15, the attribute information acquired in step S16, and the related information acquired in step S17 (S18).

In the present embodiment, in the work instruction contents, operations available for the worker W differs depending on whether the target component is a wiring line or a non-wiring component. Furthermore, in the case of a wiring line, the assembly work can be illustrated to the worker using a 3D model, and in the case of a non-wiring component, the assembly work can also be illustrated to the worker using a 2D model.

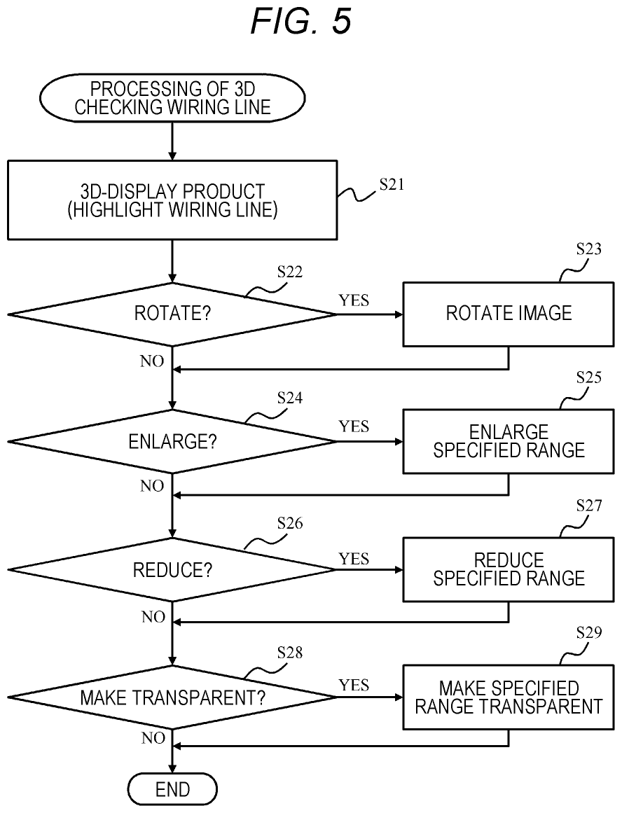

FIG. 5 is a flowchart showing processing of checking the wiring assembly work at the work site 2. On the work instruction screen 300 of the work instruction terminal 23, the wiring line 28 and the semi-finished product of the product 25, which are the objects of the assembly work, are displayed as a 3D model (S21). The wiring line is highlighted so that the wiring line being the object can be easily identified (S21).

By touching the 3D model displayed in the first pane 310 of the work instruction screen 300 with a fingertip, the worker W can perform predetermined operations (an example of “first predetermined operation”) such as rotation (S22, S23), enlargement (S24, S25), reduction (S26, S27), and transparency (S28, S29).

That is, for example, when connecting the connection destination on the front side of the product 25 and the connection destination on the back side of the product 25 by wiring, the worker rotates the 3D model (S22: YES, S23) and checks each of the connection destination on the front side and the connection destination on the back side. In addition, for example, when it is necessary to pass the wiring line through the intricate portion of the component, the worker checks from where and how to pass the wiring line through by performing an enlarged-display on the intricate portion (S24: YES) (S25). Furthermore, for example, when checking the entire routing of wiring lines, the worker checks the entire routing of wiring lines (S27) by reducing the display (S26: YES) so that the entire wiring lines can be seen. Furthermore, for example, when the wiring line is provided through the back of another component, the worker checks the hidden portion (S29) by transparently displaying the component (S28: YES).

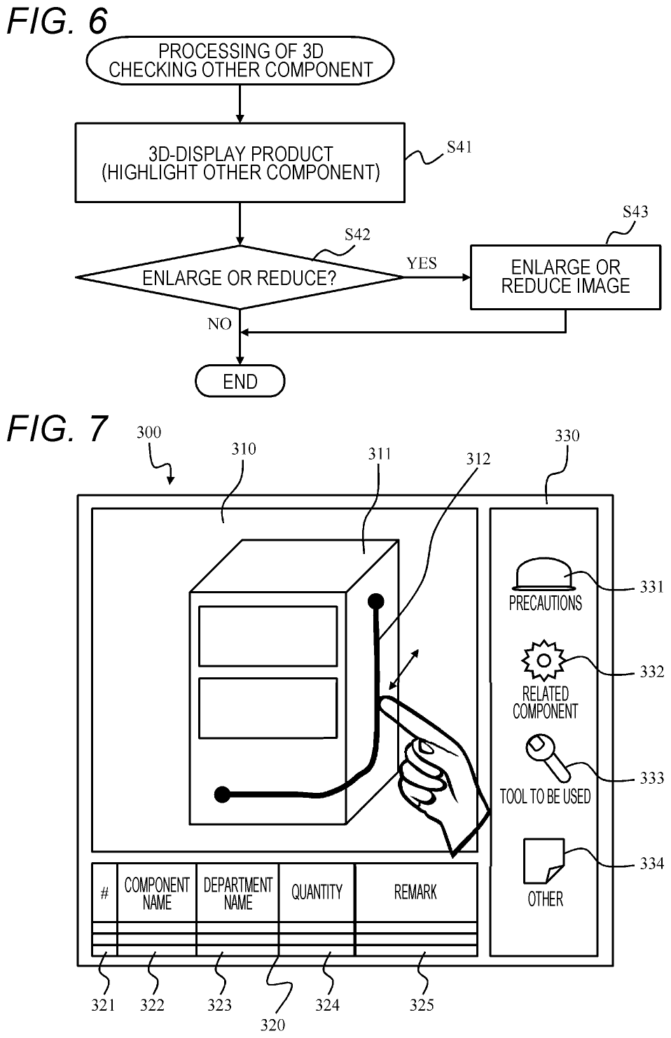

FIG. 6 is a flowchart showing processing of checking components other than wiring lines at the work site 2. A 3D model of components other than wiring lines (non-wiring components) is displayed in the first pane 310 of the work instruction screen 300 (S41). The worker can enlarge or reduce the display by touching with a fingertip the model of the semi-finished product provided with non-wiring components (S42, S43). These enlarged display and reduced display are examples of the “second predetermined operation”.

In the case of non-wiring components, the mounting position and mounting method are easier to understand unlike those of wiring lines, which limits the method for checking the screen by the worker. As described above, in the case of non-wiring components, the method of the assembly work may be illustrated using the 2D model, that is, a two-dimensional image, rather than the 3D model.

FIG. 7 shows an example of the work instruction screen 300. As described above, the work instruction screen 300 is displayed on the screen of the work instruction terminal 23. The work instruction screen 300 includes a first pane 310 positioned in the center of the screen, a second pane 320 positioned below the first pane 310, and a third pane 330 positioned on the right side of the first pane 310.

In the first pane 310, a three-dimensional model (3D model) 311 of the product 25 and a three-dimensional model 312 of the component (wiring line in this case) to be the target of the work procedure are displayed. The three-dimensional model 312 of the component to be worked on can be highlighted so that its position and shape can be distinguished from other components.

In the second pane 320, the attribute information on the component targeted for the work procedure is displayed in a tabular format. The attribute information on the component can include, for example, number 321, component name 322, department name 323, quantity 324, and remark 325.

In the third pane 330, information that cannot be transmitted to the worker only by the three-dimensional models 311 and 312 and the attribute information is displayed as related information. The related information can include, for example, precautions 331 such as manufacturing knacks (know-how) and points to note, information 332 on other components related to the target component, information 333 on tools used for assembly work of the target component, and all or part of the other information 334.

The related component information 332 includes, for example, points to note on related components during work on the target component. The other information 334 is information described according to the delivery destination of the product 25, and the items can be appropriately customized according to the delivery destination.

The worker checks the contents of the work instruction screen 300 displayed on the work instruction terminal 23 before starting the work. The worker checks in advance which points to be paid attention to when working and then starts the work. Here, an inexperienced worker is required to visually check all the information displayed in each pane 310 to 330, but a skilled worker does not necessarily have to visually check all the information. This is because they often learn work procedures through experience. Thus, in the present embodiment, among the related information 331 to 334, the display of at least a part of information can be suppressed. Suppressing the display means, for example, displaying only the item name of the related information and displaying the details when the worker operates the item name. That is, all the related information can be displayed as needed by the worker, without being displayed in the third pane 330 from the beginning. Thus, more information can be provided to the worker by effectively utilizing the limited display size.

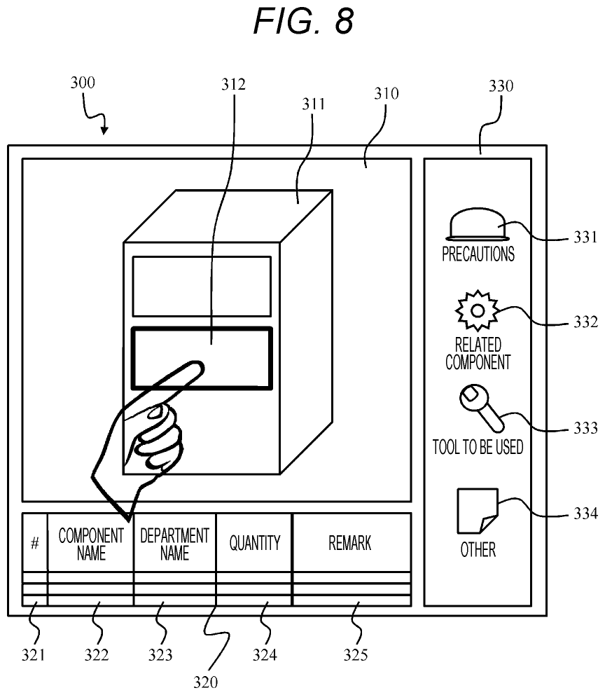

FIG. 8 is another example of the work instruction screen 300. In FIG. 8, a 3D model of the non-wiring component and a 3D model of a semi-finished product of the product 25 are displayed in the first pane 310.

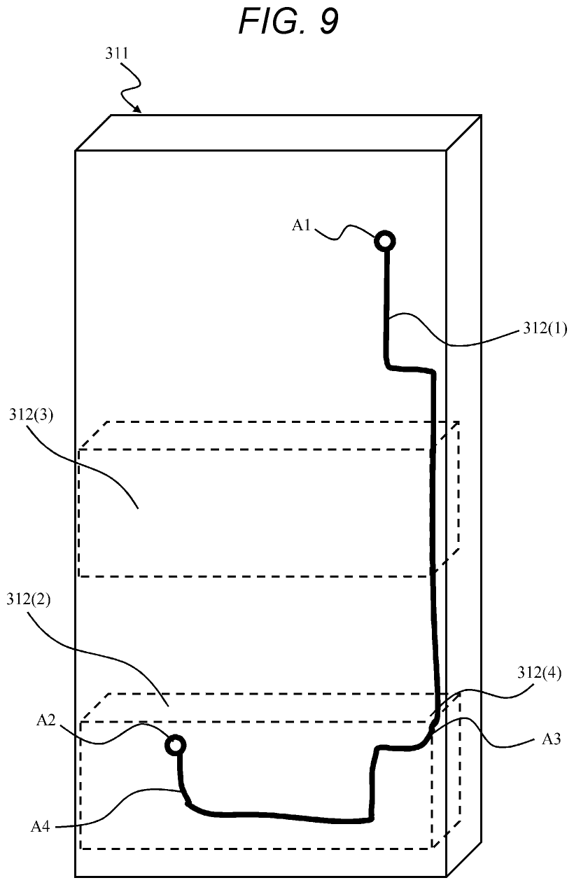

FIG. 9 is an example schematically showing a 3D model for illustrating the assembly work. The 3D model 311 of the product displays the 3D model 312 (1) of the wiring line and the 3D models 312 (2) to (4) of the non-wiring components.

The wiring model 312 (1) shown in FIG. 9 includes, for example, connection destination portions A1 and A2 at both ends, a portion A3 passing through another component 312 (4), and a portion A4 hidden by another component 312 (2).

The worker can check an assembly method of the wiring line by performing rotational display, enlarged display, reduced display, and transparent display on the 3D models 311 and 312 as shown in FIG. 9.

According to the present embodiment configured in this way, the work instruction screen 300 that includes: the first pane 310 for displaying the three-dimensional models 311 and 312 of the product 25 and the work component 28 to be worked on, the second pane 320 for displaying the attribute information of the component, and the third pane 330 for displaying related information associated with a predetermined component code, can be provided to the worker. Thus, the worker can three-dimensionally grasp the contents of the work procedure, and can check information difficult to convey with the three-dimensional model, such as points to note. As a result, according to the present embodiment, it is possible to promote understanding of the work procedure to improve workability, and also possible to suppress dispersion in manufacturing quality.

Furthermore, according to the present embodiment, the wiring line routed in the product 25 by a complicated route difficult to understand can be easily checked via the 3D model, so that the wiring assembly work can be efficiently checked and understood, and the workability is improved.

Furthermore, in the present embodiment, a 3D model can be used for wiring assembly work, and a 2D model can be used for non-wiring component assembly work. Therefore, according to the present embodiment, a detailed illustration screen and a simplified illustration screen can be used properly depending on the technical nature of the object, and the work instruction system 11 can be achieved using computer resources efficiently.

### Second Embodiment

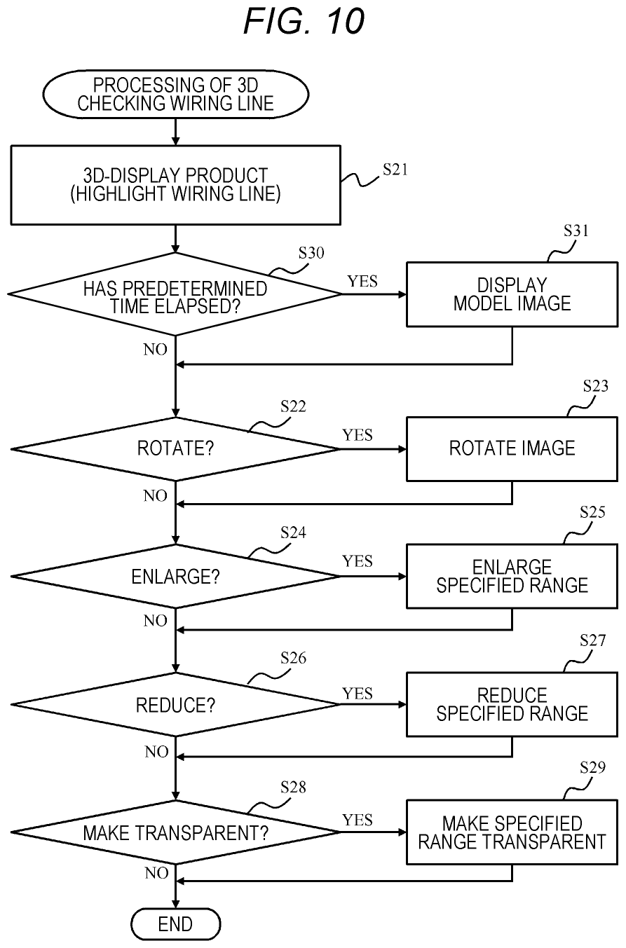

The second embodiment will be described with reference to FIG. 10. In each of the following embodiments including the present embodiment, the differences from the first embodiment will be mainly described. In the present embodiment, when the 3D model displayed on the work instruction terminal 23 is not operated by the worker for a predetermined time or more, a model image prepared in advance is displayed.

FIG. 10 is a flowchart of the processing of checking the wiring assembly work at a work site. The processing shown in FIG. 10 includes all steps S21 to S29 of the processing described in FIG. 5. Furthermore, in the present embodiment, between step S21 and step S22, if the 3D model is not operated even after the elapse of a predetermined time after the 3D model is displayed in step S21 (S30: YES), the model image prepared in advance is displayed on the work instruction terminal 23 (S31). The model image is, for example, an image demonstrating an assembly work by a skilled worker, or an animation image of the assembly work.

The present embodiment thus configured also produces the same action and effect as the first embodiment. Furthermore, according to the present embodiment, if the 3D model is not operated within a predetermined time after the 3D model is displayed on the work instruction terminal 23, the model image is displayed on the work instruction terminal 23, so that it is possible to save as much the waste of time as possible and teach inexperienced workers the method of the assembly work.

### Third Embodiment

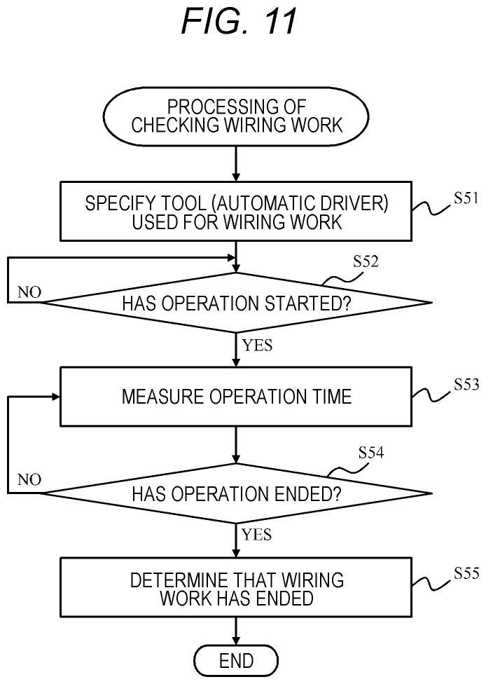

The third embodiment will be described with reference to FIG. 11. In the present embodiment, the completion of the assembly work is automatically identified from the operating situation of the tool used for the assembly work. Here, the wiring work will be described as an example of the assembly work.

FIG. 11 is a flowchart showing processing for checking the completion of the wiring work. The present processing is implemented by, for example, the work analysis unit 125 or the work situation monitoring unit 121 of the work improvement support system 1. In the following, the work improvement support system 1 will be described as the main body of operation.

The work improvement support system 1 specifies the tool used for the wiring work (S51) and determines whether the specified tool has started operation (S52). The third pane 330 of the work instruction screen 300 contains information 333 about the tool to be used. The work improvement support system 1 can grasp the information on the tool used for the wiring work from the information 333.

The work improvement support system 1 can determine whether the specified tool has operated by analyzing the image taken by the camera 24. The sound of the work site 2 may be collected and analyzed instead of or together with the image analysis. Alternatively, a vibration sensor, a current sensor, a voltage sensor, or the like can be attached to the tool, and it can also be determined from the signals of these sensors whether the tool has started operation.

If detecting the start of operation of the tool (S52: YES), the work improvement support system 1 measures the operation time (S53). The work improvement support system 1 determines whether the operation of the tool has ended in the same manner as described in step S52 (S54). The work improvement support system 1 continues measuring the operating time (S53) until the operation of the tool ends (S54: NO).

If determining that the operation of the tool has ended (S54: YES), the work improvement support system 1 determines that the wiring work has ended (S55). The work improvement support system 1 causes the work instruction screen 300 to display work instructions for the next assembly work.

The present embodiment thus configured also produces the same action and effect as the first embodiment. Furthermore, according to the present embodiment, the work improvement support system 1 monitors the operating situation of the tool used for the assembly work (for example, the wiring work), thereby being able to grasp whether or not the assembly work has ended and the time required for the work.

Therefore, the worker does not need the time and effort to input the end of the work onto the work instruction screen 300, and the usability is improved. The present embodiment can be applied to both the first and second embodiments.

### Fourth Embodiment

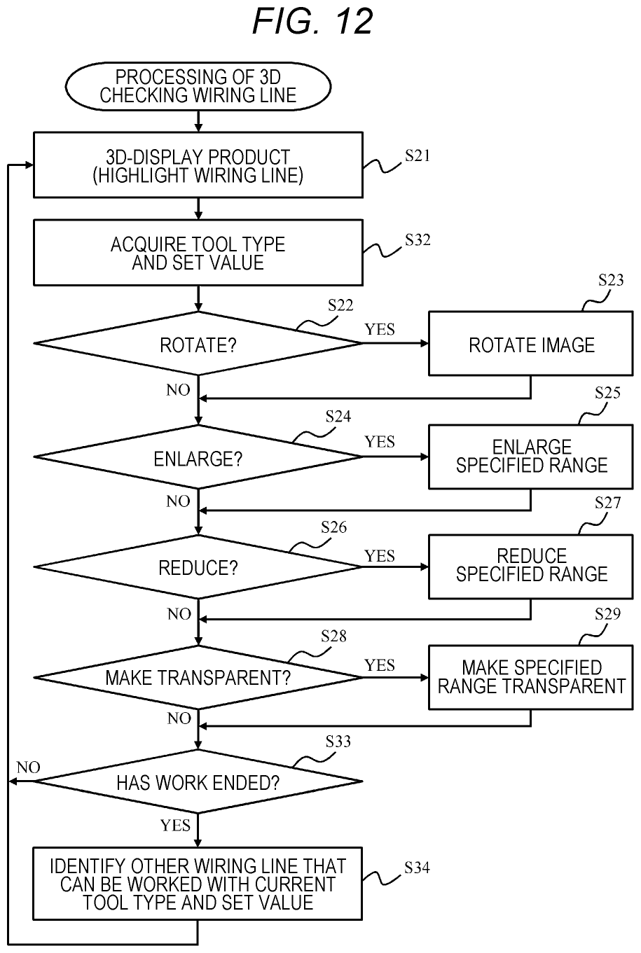

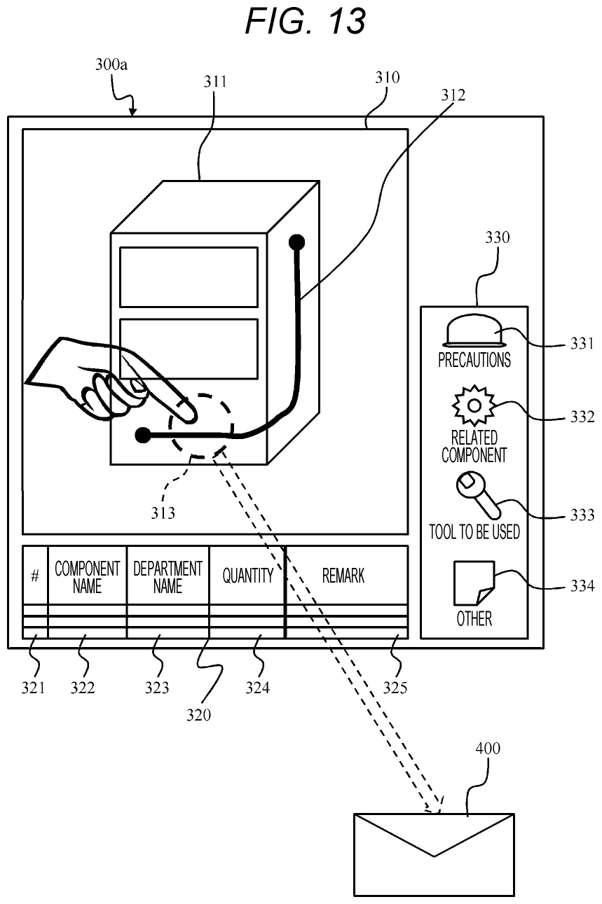

The fourth embodiment will be described with reference to FIG. 12. In the present embodiment, the workable wiring can be preferentially specified by the tool and the set value of the tool.

FIG. 12 is a flowchart of processing for checking the wiring assembly work. The processing shown in FIG. 12 includes all steps S21 to S29 of the processing described in FIG. 5. Furthermore, in the present embodiment, the tool used for the wiring work and the set value of the tool are acquired between step S21 and step S22 (S32). Furthermore, in the present embodiment, it is determined whether the operation of the 3D model by the worker is completed (S33). If it is determined that the wiring work is completed (S33: YES), another wiring line that can be worked with the current tool and set value is identified, and is displayed on the work instruction screen 300 (S34).

The present embodiment thus configured also produces the same action and effect as the first embodiment.

Furthermore, in the present embodiment, when the order of wiring work can be changed (when the order is not absolute), the wiring line that can be worked with the tool and set value specified in step S32 is identified and presented to the worker, so that usability and workability can be further improved. The present embodiment can be applied to any of the first to third embodiments.

### Fifth Embodiment

The fifth embodiment will be described with reference to FIGS. 13 to 15. In the present embodiment, the points that the worker has noticed during the assembly work can be fed back to the designer or the like by e-mail 400, whereby this helps improve the work instruction screen 300.

FIG. 13 is an example of the work instruction screen 300a according to the present embodiment. The worker may notice points to be improved or problems while working as indicated in the work procedure. In the following, a case where a problem is noticed will be described as an example.

For example, during mounting the target component, when noticing that there is a risk of interference with other components or noticing a problem such as difficulty in assembling, the worker marks the problematic portions on the three-dimensional models 311 and 312 with the worker's fingertips or the like.

In particular, wiring work has technical nature such as connecting distant portions, needing to route the wiring line between components in a meandering manner, inserting tools through from narrow gaps, and needing to support the middle because of the soft wire material. Therefore, during the actual wiring work at the work site 2, problems (points to be improved) with respect to the work instructions may be noticed. In the present embodiment, the points to be improved noticed at the work site 2 are fed back to the upstream process.

In the present embodiment, the work instruction terminal 23 preferably includes a touch panel. However, the work instruction terminal 23 is not limited to the touch panel, and has only to be a device that can specify the portion of the problems (points to be improved) on the three-dimensional model.

After marking the problematic portion, the worker adds a text message or a voice message to generate an e-mail 400 and sends it to a pre-registered destination. The worker can write a text message from a virtual keyboard or a physical keyboard, or record a voice from a microphone (not shown) provided in the work instruction terminal 23. The e-mail 400 configured in this way includes, for example, an image of a problematic portion, a message, worker identification information, a work procedure number, and the like.

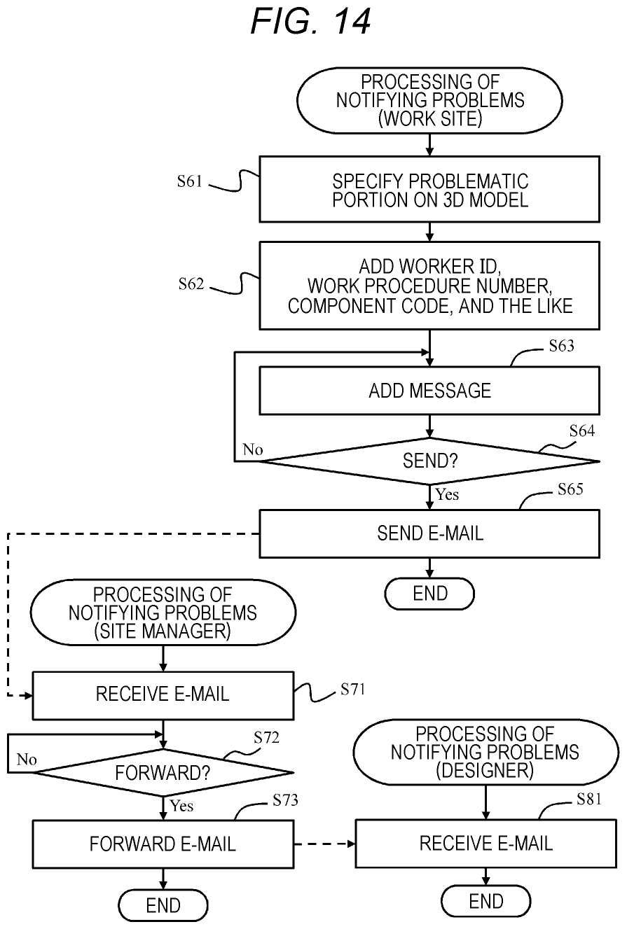

FIG. 14 is a flowchart showing processing of notifying related parties of a problem found at the work site 2 as an e-mail 400 from the work instruction screen 300.

As described above, the worker who notices the problem marks the problematic portion on the three-dimensional model displayed in the first pane 310. The work instruction system specifies the problematic portion based on the input operation from the worker (S61), and adds the management information to the e-mail 400 (S62). The management information is a bibliographic item necessary for problem analysis, and is, for example, a worker ID, a work procedure number, a component code, and the like. The worker can easily designate the position where the problem occurs on the three-dimensional model, and the workability of reporting is improved.

Furthermore, the work instruction system 11 adds the message entered by the worker to the e-mail 400 (S63). If detecting that the worker has instructed sending an e-mail (S64: YES), the work instruction system 11 sends the e-mail 400 to a predetermined destination registered in advance (S65).

Examples of the predetermined destination can include the manager of the work site 2, the designer of the product 25, and the creator of the work instruction contents. In the present embodiment, problems found at each work site 2 are once collected to the site manager, and when the site manager determines that it is necessary, the e-mail 400 is forwarded to the designer or the like.

That is, if the site manager receives the e-mail 400 with the terminal 27 the site manager uses (S71), the site manager determines whether it should be forwarded to the designer or the like. If detecting that the forwarding instruction has been input (S72: YES), the terminal 27 of the site manager forwards the e-mail 400 received in step S31 to the designer or the like (S73).

Temporarily collecting to the site manager the e-mail 400 sent via the work instruction screen 300 from the worker rather than directly sending it to the designer prevents unnecessary e-mail 400 from being sent to the designer. This is because the problem found by the worker may be caused by the worker's misunderstanding, immaturity, or the like.

The designer of the product 25 (and/or the creator of the work instruction contents) receives (S81) with a terminal (not shown) such as a personal computer the e-mail 400 forwarded from the terminal 27 of the site manager, and checks the e-mail 400. The received e-mail 400 is managed by, for example, the database server 1004.

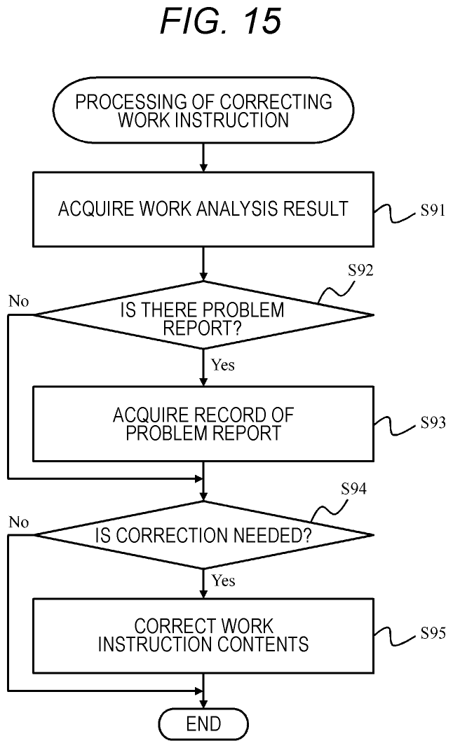

FIG. 15 is a flowchart showing processing of correcting the work instruction contents. Here, a case where the designer terminal corrects the work instruction contents will be described.

The designer terminal acquires the work analysis result from the work analysis system 12 (S91). The designer terminal accesses the database server 1004 to check if there is a problem report (S92). If there is a problem report (S92: YES), the designer terminal acquires the email 400 reporting the problem from the database server 1004 (S93).

The designer terminal determines whether the contents of the work instruction contents should be corrected from the work analysis result and the problem report (S94).

For example, if the bottleneck work extracted from the work analysis result and the work procedure in which the problem is reported match, it can be determined that the work instruction contents should be corrected in order to improve the work procedure. The bottleneck work is, for example, a work in which the time required to complete the work is longer than the target value.

The lengthening of the working hours depends on the skill level or the like of the worker, but there may be points to be improved in the way of conveying work instructions. In this case, for example, the relationship with easily overlooked peripheral components, and the precautions regarding easily mistaken tools, are newly created and included in the related information. On the other hand, if there are points to be improved in the design of the product 25, the design data can be reviewed and corrected.

The present embodiment thus configured also produces the same action and effect as the first embodiment. Furthermore, according to the present embodiment, since the worker can report the points noticed during the work from the work instruction screen 300, the notices at the work site 2 can be easily collected. Then, in the present embodiment, since the work instruction contents can be corrected based on the work analysis result in the work analysis system 12 and the report from the work site 2, the work instruction screen 300 easier to understand can be provided to the worker. Thus, the workability of the assembly work can be improved, and the occurrence of bottleneck work can be suppressed. The present embodiment can be applied to any of the first to fourth embodiments.

It should be noted that the present invention is not limited to the above-described embodiments. A person skilled in the art can make various additions and changes within the scope of the present invention. In the above-described embodiments, the configuration is not limited to the configuration example shown in the accompanying drawings. The configuration and processing method of the embodiment can be appropriately changed within the scope of achieving the object of the present invention.

In addition, each component of the present invention can be optionally selected, and an invention having the selected configuration is also included in the present invention.

Furthermore, the configurations described in the claims can be combined in addition to the combinations explicitly specified in the claims.

### REFERENCE SIGNS LIST

1 work improvement support system
2 work site
11 work instruction system
12 work analysis system
21 cell
22 RFID reader
23 work instruction terminal
24 camera
25 product
28 component
111 3D CAD data storage unit
112 assembly order storage unit
113 assembly order registration unit
114 work instruction generation unit
115 work instruction display unit
116 work instruction management table
300, 300a work instruction screen
310 first pane
311, 312 three-dimensional model
320 second pane
330 third pane

1. A work instruction system configured to display a work instruction on assembly work, the work instruction system comprising:
a computer configured to generate a work instruction screen; and
a display device connected to the computer and configured to display the work instruction screen,
wherein the work instruction screen includes
a first display region in which a three-dimensional model used for describing an assembly work of an object is displayed based on three-dimensional design data,
a second display region in which at least a part of attribute information of the three-dimensional design data is displayed, and
a third display region in which when predetermined component information registered in advance is included in the attribute information, related information associated with the predetermined component information is displayed, and
in the first display region, when the object is a wiring line, the three-dimensional model is displayed for allowing a first predetermined operation.

2. The work instruction system according to claim 1, wherein the first predetermined operation is an operation for checking a predetermined region including at least one of
a portion where the wiring line is connected to a component of a connection destination,
a portion where the wiring line is hidden by another component, and
a portion where the wiring line goes through another component.

3. The work instruction system according to claim 2, wherein in the first display region, when the object is other than a wiring line, the three-dimensional model is displayed for allowing a second predetermined operation different from the first predetermined operation.

4. The work instruction system according to claim 3, wherein the related information can include at least one of
work precautions,
information on a predetermined tool necessary for operating the object, and
information on the object or a predetermined object related to the object.

5. The work instruction system according to claim 1, wherein the computer generates a message in response to an operation on the work instruction screen and causes a generated message to be sent to a predetermined destination registered in advance.

6. The work instruction system according to claim 1, wherein the computer can acquire an analysis result of a work performed based on the work instruction screen and correct the work instruction screen based on the analysis result.

7. A work instruction system configured to display a work instruction on assembly work, the work instruction system comprising:
a computer configured to generate a work instruction screen; and
a display device connected to the computer and configured to display the work instruction screen,
wherein the work instruction screen includes
a first display region in which a three-dimensional model used for describing an assembly work of an object is displayed based on three-dimensional design data,
a second display region in which at least a part of attribute information of the three-dimensional design data is displayed, and
a third display region in which when predetermined component information registered in advance is included in the attribute information, related information associated with the predetermined component information is displayed, and
in the first display region,
when the object is a wiring line, a three-dimensional model based on the three-dimensional design data is displayed for allowing a first predetermined operation, and
when the object is other than a wiring line, a plane model based on the three-dimensional design data is displayed for allowing a second predetermined operation different from the first predetermined operation.

8. A work instruction method for causing a work instruction regarding an assembly work to be displayed from a computer to a display device, the work instruction method comprising in the computer:
generating a work instruction screen including
a first display region in which a three-dimensional model used for describing an assembly work of an object is displayed based on three-dimensional design data,
a second display region in which attribute information on the object is displayed, and
a third display region in which related information that is associated with the attribute information and that includes at least work precautions is displayed;
transmitting a generated work instruction screen to the display device to cause the display device to display the generated work instruction screen; and
in the first display region, when the object is a wiring line, causing the three-dimensional model to be displayed for allowing a first predetermined operation.
